(19) United States
(12) Patent Application Publication
(10) Pub. No.: US 2019/0178094 A1
(43) Pub. Date: Jun. 13, 2019

(54) INTEGRALLY BLADED ROTOR

(71) Applicant: United Technologies Corporation, Farmington, CT (US)

(72) Inventor: Peter Todd Schutte, Manchester, CT (US)

(21) Appl. No.: 16/169,353

(22) Filed: Oct. 24, 2018

Related U.S. Application Data
(60) Provisional application No. 62/580,843, filed on Nov. 2, 2017.

(51) Int. Cl. F01D 5/34; F01D 5/14

(52) U.S. Cl. CPC F01D 5/34; F01D 5/148; F05D 2240/303; F05D 2220/32; F05D 2240/305; F05D 2240/306; F05D 2240/307; F05D 2240/304

(57) ABSTRACT

An integrally bladed rotor for a gas turbine engine includes a rotor portion with an outer periphery. At least one airfoil includes a suction side and a pressure side extending between a leading edge and a trailing edge. The at least one airfoil extends radially from the outer periphery and has an airfoil thickness between the suction side and the pressure side. A first thickness on at least one of the pressure side and suction side of the airfoil in addition to the airfoil thickness that extends radially from the outer periphery defines a crack propagation boundary. A method of fabricating an integrally bladed rotor for a gas turbine engine is also disclosed.

### CROSS REFERENCE TO RELATED APPLICATION

This application claims priority to the U.S. Provisional Application No. 62/580,843, which was filed on Nov. 2, 2017, and is incorporated herein by reference.

### BACKGROUND

A gas turbine engine typically includes a fan section, a compressor section, a combustor section and a turbine section. Air entering the compressor section is compressed and delivered into the combustion section where it is mixed with fuel and ignited to generate a high-energy exhaust gas flow. The high-energy exhaust gas flow expands through the turbine section to drive the compressor and the fan section. The compressor section typically includes low and high pressure compressors, and the turbine section includes low and high pressure turbines.

The compressor and turbine sections include airfoils supported on rotors. The airfoils may be separate parts assembled to a rotor or may also be integrally formed as part of the rotor. Forming the rotor and airfoils as a single part reduces the number of parts and eliminates the need for fastening systems for securing airfoils to the rotor.

Turbine engine manufacturers continue to seek improvements to turbine engines including improvements in assembly, manufacture, engine performance and propulsive efficiencies.

### SUMMARY

In a featured embodiment, an integrally bladed rotor for a gas turbine engine includes a rotor portion with an outer periphery. At least one airfoil includes a suction side and a pressure side extending between a leading edge and a trailing edge. The at least one airfoil extends radially from the outer periphery and has an airfoil thickness between the suction side and the pressure side. A first thickness on at least one of the pressure side and suction side of the airfoil in addition to the airfoil thickness that extends radially from the outer periphery defines a crack propagation boundary.

In another embodiment according to the previous embodiment, the first thickness includes a first fillet between the outer periphery and the airfoil and further includes a second fillet radially outward from the first fillet. The second fillet has a second radius smaller than the first radius.

In another embodiment according to any of the previous embodiments, the first fillet extends radially from the outer periphery a first distance to an interface and the second fillet begins at the interface.

In another embodiment according to any of the previous embodiments, the interface is spaced apart from at least one of the suction side and pressure side of the airfoil a first width.

In another embodiment according to any of the previous embodiments, the second fillet extends from the interface to one of the pressure side and suction side of the airfoil.

In another embodiment according to any of the previous embodiments, the first distance includes a smooth transition from the outer periphery to the interface.

In another embodiment according to any of the previous embodiments, the first fillet and the second fillet are on one of the pressure side and the suction side.

In another embodiment according to any of the previous embodiments, the first fillet and the second fillet are disposed on both the suction side and the pressure side.

In another embodiment according to any of the previous embodiments, the first thickness includes a patch portion disposed on one of the suction side and the pressure side extending partway between the leading edge and the trailing edge.

In another featured embodiment, an integrally bladed rotor for a gas turbine engine includes a rotor portion with an outer periphery. At least one airfoil includes a suction side and a pressure side extending between a leading edge and a trailing edge. The at least one airfoil extends radially from the outer periphery. The airfoil includes an airfoil thickness between the pressure side and the suction side. A patch portion disposed on one of the suction side and the pressure side extends partway between the leading edge and the trailing edge. The patch portion includes a first thickness added to the airfoil thickness.

In another embodiment according to the previous embodiment, the patch portion includes a first fillet providing a smooth transition from the outer periphery.

In another embodiment according to any of the previous embodiments, the patch portion is disposed on the suction side at the leading edge.

In another embodiment according to any of the previous embodiments, the patch portion is spaced apart from the trailing edge.

In another embodiment according to any of the previous embodiments, the patch portion is spaced apart from the leading edge.

In another featured embodiment, a method of fabricating an integrally bladed rotor for a gas turbine engine includes forming a rotor portion with an outer periphery. At least one airfoil is formed extending radially from the outer periphery to include a suction side and a pressure side extending between a leading edge and a trailing edge. The at least one airfoil is formed to include an airfoil thickness between the pressure side and the suction side. A first thickness is formed on at least one of the pressure side and suction side of the airfoil in addition to the airfoil thickness.

In another embodiment according to the previous embodiment, forming the first thickness as a patch portion disposed on one of the suction side and the pressure side extending partway between the leading edge and the trailing edge.

In another embodiment according to any of the previous embodiments, forming the patch portion includes forming the patch portion on the suction side at the leading edge and spaced apart from the trailing edge.

In another embodiment according to any of the previous embodiments, forming the first thickness includes forming a first fillet between the outer periphery and at least one of the pressure side and suction side of the airfoil to have a first radius and forming a second fillet radially outward from the first fillet to have a second radius smaller than the first radius.

In another embodiment according to any of the previous embodiments, forming the first fillet to extend radially from the outer periphery a first distance to an interface and forming the second fillet to begin at the interface.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is a perspective view of an example integrally bladed rotor.

FIG. 3 is a perspective view of an example airfoil embodiment.

FIG. 4 is a cross-sectional view of a portion of the example airfoil embodiment.

FIG. 5 is an enlarged perspective view of a portion of an example airfoil embodiment.

FIG. 6 is another perspective view of an example airfoil embodiment.

FIG. 7 is a perspective view of another example airfoil embodiment.

FIG. 8 is a cross-sectional view of a portion of the example airfoil shown in FIG. 7.

FIG. 9 is a cross-section of another portion of the example airfoil shown in FIG. 7.

### DETAILED DESCRIPTION

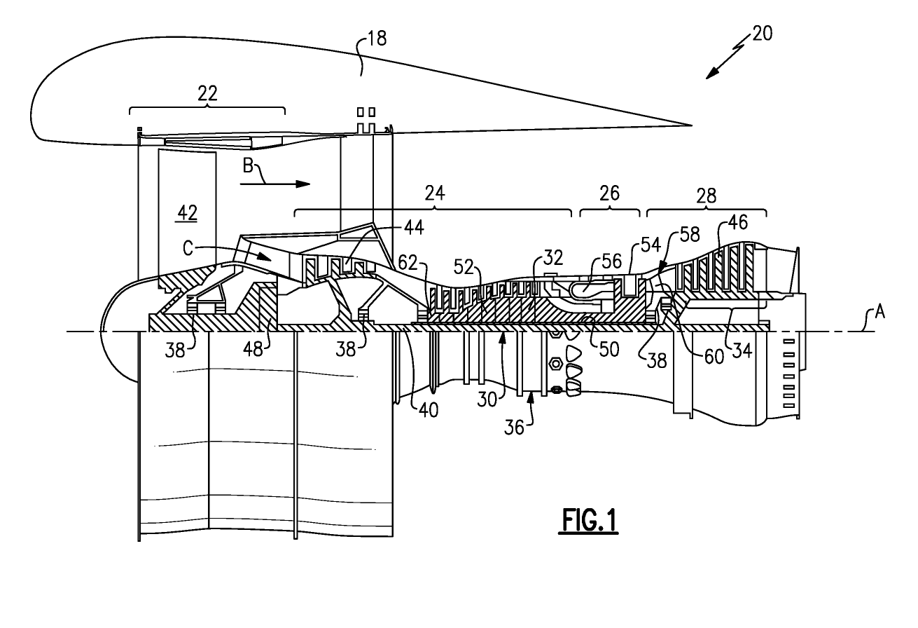

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 18, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 58 of the engine static structure 36 is arranged generally between the high pressure turbine 54 and the low pressure turbine 46. The mid-turbine frame 58 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 58 includes airfoils 60 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle.

The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFCT’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 meters/second).

The example gas turbine engine includes the fan 42 that comprises in one non-limiting embodiment less than about twenty-six (26) fan blades. In another non-limiting embodiment, the fan section 22 includes less than about twenty (20) fan blades. Moreover, in one disclosed embodiment the low pressure turbine 46 includes no more than about six (6) turbine rotors schematically indicated at 34. In another non-limiting example embodiment the low pressure turbine 46 includes about three (3) turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

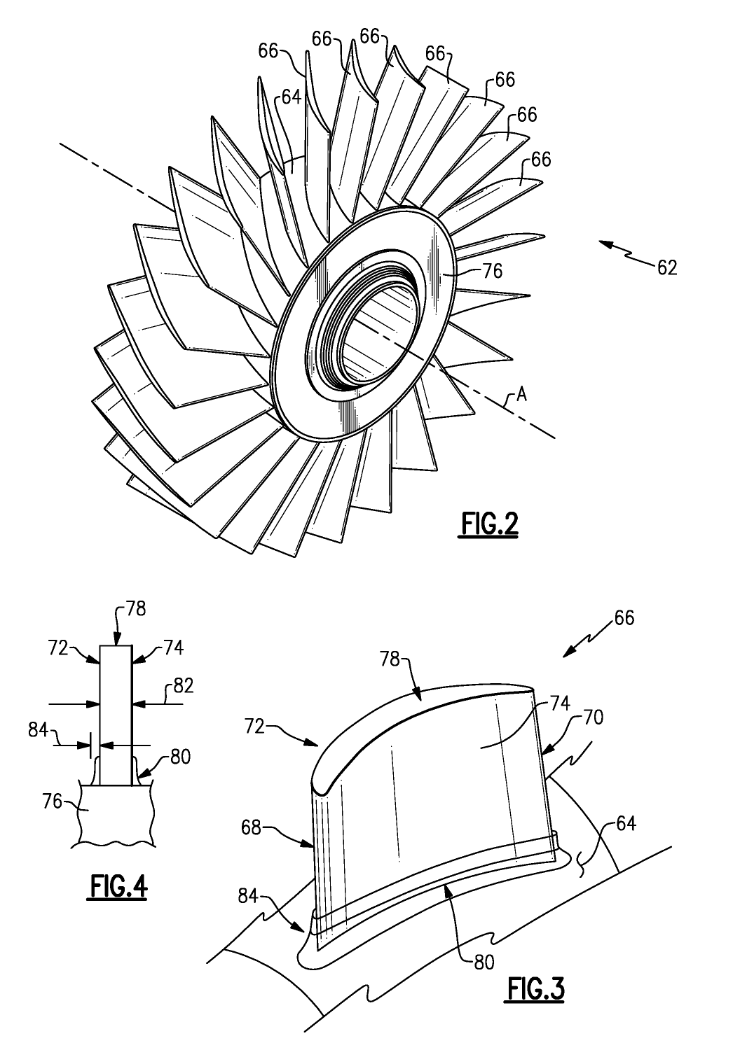

Referring to FIG. 2 with continued reference to FIG. 1, the example gas turbine engine 20 includes the compressor section 52 that includes a plurality of integrally bladed rotors 62 (IBR). Each of the IBRs 62 includes a rotor portion 76 defining an outer periphery 64. A plurality of airfoils 66 extend upward from the outer periphery 64. The IBR 62 is a one-piece part with portions that define, among other features, the rotor 76, periphery 64 and the airfoils 66.

Referring to FIG. 3 with continued reference to FIG. 2, each of the plurality of airfoils 66 includes a leading edge 68, a trailing edge 70, a suction side 72 and a pressure side 74. Each of the airfoils 66 extends radially outward from the periphery 64 defined in the IBR 62. The airfoils 66 extend from a root portion 80 to a tip portion 78. The root portion 80 is defined at the periphery 64 of the rotor portion 76. A thickness 84 is disposed near the root 80 and extends between the peripheral surface 64 and side surfaces of the airfoil 66.

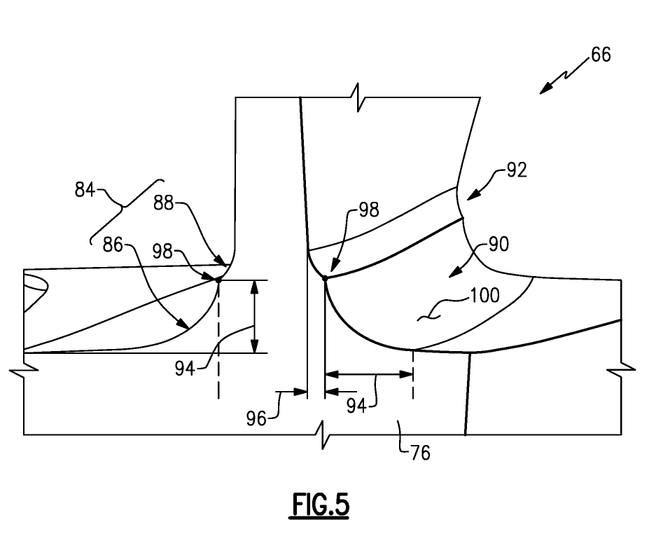

Referring to FIG. 4 with continued reference to FIGS. 2 and 3, the example thickness 84 is disposed at the root portion 80 about the airfoil 66 and provides a boundary to prevent crack propagation from the airfoil 66 into the rotor portion 76 of the IBR 62. In this example, the thickness 84 extends outward from an airfoil thickness 82 defined between the pressure side 72 and the suction side 74.

Referring to FIG. 5 with continued reference to FIGS. 3 and 4, in one disclosed embodiment, the first thickness 84 includes a first fillet 86 that extends from the rotor periphery 64 to an interface 98 and a second fillet 88 that extends radially outward from the interface 98. The first fillet 86 includes a transition surface 100 that extends from the periphery 64 to the interface 98. The interface 98 is disposed a distance 94 above the peripheral surface 64 and a width 96 away from the pressure side 72 and suction side 74 of the airfoil 66. The disclosed interface 98 is the interface between the first fillet 86 and the second fillet and is the location where the surface 100 transitions from a first radius 90 to a second radius 92. Accordingly, the second fillet 88 begins at the interface 98 and extends upward radially at the second radius 92 into a smooth transition that merges with the pressure and suction surfaces of the airfoil 66.

In the disclosed example embodiment, the first radius 90 is larger than the second radius 92. In one disclosed embodiment, the first radius 90 is between one third and one half greater than the second radius 92. In another disclosed embodiment, the first radius 90 is about 0.120 inches (3.048 mm) and the second radius is 0.080 inches (2.032 mm). In another disclosed embodiment the first radius is about 0.090 inches (2.286 mm) and the second radius is about 0.050 inches (1.27 mm). In another disclosed dimensional embodiment, the first radius is about 0.150 inches (3.81 mm) and the second radius is about 0.0120 inches (0.3048 mm). Moreover, in one example embodiment, the width 96 is between about 0.010 inches (0.254 mm) and 0.030 inches (0.762 mm). In other disclosed embodiment the width 96 is about 0.020 inches (0.508 mm). It should be understood, that the disclosed dimensional embodiment is provided by way of example and other radiuses and widths could be utilized and are within the contemplation of this disclosure.

It should be understood that although dimensional embodiments are disclosed by way of example, the first fillet 86 is larger than the second fillet 88. The specific relative size between the first fillet 86 and the second fillet 88 may be different to provide a predefined stress propagation path that prevents crack propagation radially inward into the rotor 76.

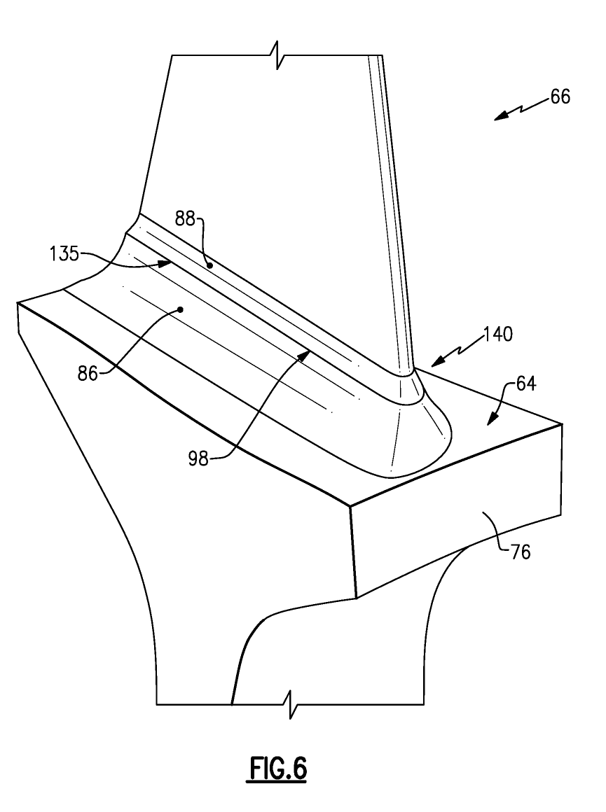

Referring to FIG. 6, with continued reference to FIG. 5, the separation at the interface 98 between the first fillet 86 and the second fillet 88 defines a crack propagation boundary schematically shown at 135. A potential crack schematically referred to as 140 is prevented from propagating radially inward toward the rotor portion 76 by the thicker portions of the airfoil defined by the first fillet 86. Instead, the crack 140 propagates in direction substantially along and parallel to the interface 98. Accordingly, the interface 98 defines the crack propagation boundary and prevents cracks from propagating into the rotor portion 76.

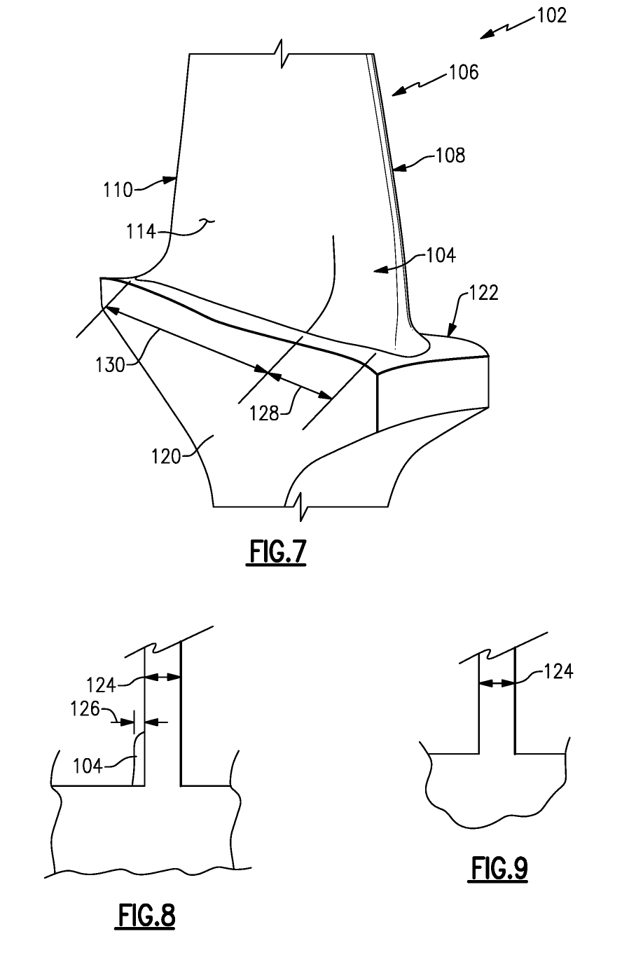

Referring to FIGS. 7, 8 and 9, another example IBR 102 embodiment is schematically illustrated and includes an airfoil 106 with a suction side 112 and a pressure side 114 that extends between a leading edge 108 and a trailing edge 110. The airfoil 106 extends upward from a rotor peripheral surface 122 and includes a patch portion 104. In this example, the patch portion 104 is disposed on the pressure side 114 and extends a distance 128 from the leading edge 108 toward the trailing edge 110. The patch 104 is therefore spaced apart a distance 130 away from the trailing edge 130. The patch 104 is disposed at a location between the airfoil 102 and peripheral surface 122 that defines a boundary that prevents crack propagation into the rotor 120. Moreover, the area of the increased thickness 126 provided by the patch 104 is based on stress analysis of potential crack propagation and may vary in location and thickness.

The patch 104 is an increased thickness indicated at 126 (FIG. 8) that is greater than the airfoil thickness 124. The airfoil thickness 124 may vary depending on the airfoil shape between the leading edge and the trailing edge. The patch portion 104 includes a thickness 126 in addition to the airfoil thickness 124 of the airfoil 102 in a specific location near the leading edge 108. The location of the thickness 126 is provided based on analysis of stresses inflicted on the airfoil 102 during operation. The increased thickness 126 is shown on one side of the airfoil 102, but may extend to both sides of the airfoil 102. Moreover, the patch 104 may extend different distances 128 toward the trailing edge 110 as determined to define a boundary to possible crack propagation radially inward. Moreover, the increased thickness 126 provided by the patch 104 could be spaced from the leading edge 108 or any position along the interface between the surface 122 and the airfoil 102 where a reduction in operating stress is required to direct crack propagation way from the rotor 120.

Accordingly, the example disclosed IBR 62 includes airfoils 66, 102 with features that define crack propagation boundaries to prevent cracks from propagating radially inward to into rotor portions.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. An integrally bladed rotor for a gas turbine engine comprising:
a rotor portion with an outer periphery;
at least one airfoil including a suction side and a pressure side extending between a leading edge and a trailing edge, the at least one airfoil extending radially from the outer periphery and has an airfoil thickness between the suction side and the pressure side; and
a first thickness on at least one of the pressure side and suction side of the airfoil in addition to the airfoil thickness that extends radially from the outer periphery defining a crack propagation boundary.

2. The integrally bladed rotor as recited in claim 1, wherein the first thickness comprises a first fillet between the outer periphery and the airfoil and further including a second fillet radially outward from the first fillet, wherein the second fillet has a second radius smaller than the first radius.

3. The integrally bladed rotor as recited in claim 2, wherein the first fillet extends radially from the outer periphery a first distance to an interface and the second fillet begins at the interface.

4. The integrally bladed rotor as recited in claim 3, wherein the interface is spaced apart from at least one of the suction side and pressure side of the airfoil a first width.

5. The integrally bladed rotor as recited in claim 4, wherein the second fillet extends from the interface to one of the pressure side and suction side of the airfoil.

6. The integrally bladed rotor as recited in claim 3, wherein the first distance comprises a smooth transition from the outer periphery to the interface.

7. The integrally bladed rotor as recited in claim 2, wherein the first fillet and the second fillet are on one of the pressure side and the suction side.

8. The integrally bladed rotor as recited in claim 2, wherein the first fillet and the second fillet are disposed on both the suction side and the pressure side.

9. The integrally bladed rotor as recited in claim 1, wherein the first thickness comprises a patch portion disposed on one of the suction side and the pressure side extending partway between the leading edge and the trailing edge.

10. An integrally bladed rotor for a gas turbine engine comprising:
a rotor portion with an outer periphery;
at least one airfoil including a suction side and a pressure side extending between a leading edge and a trailing edge, the at least one airfoil extending radially from the outer periphery, the airfoil including an airfoil thickness between the pressure side and the suction side; and
a patch portion disposed on one of the suction side and the pressure side extending partway between the leading edge and the trailing edge, the patch portion including a first thickness added to the airfoil thickness.

11. The integrally bladed rotor as recited in claim 10, wherein the patch portion includes a first fillet providing a smooth transition from the outer periphery.

12. The integrally bladed rotor as recited in claim 10, wherein the patch portion is disposed on the suction side at the leading edge.

13. The integrally bladed rotor as recited in claim 10, wherein the patch portion is spaced apart from the trailing edge.

14. The integrally bladed rotor as recited in claim 10, wherein the patch portion is spaced apart from the leading edge.

15. A method of fabricating an integrally bladed rotor for a gas turbine engine comprising:
forming a rotor portion with an outer periphery;
forming at least one airfoil extending radially from the outer periphery to include a suction side and a pressure side extending between a leading edge and a trailing edge, wherein the at least one airfoil is formed to include an airfoil thickness between the pressure side and the suction side; and
forming a first thickness on at least one of the pressure side and suction side of the airfoil in addition to the airfoil thickness.

16. The method as recited in claim 15, including forming the first thickness as a patch portion disposed on one of the suction side and the pressure side extending partway between the leading edge and the trailing edge.

17. The method as recited in claim 16, wherein forming the patch portion includes forming the patch portion on the suction side at the leading edge and spaced apart from the trailing edge.

18. The method as recited in claim 15, wherein forming the first thickness comprises forming a first fillet between the outer periphery and at least one of the pressure side and suction side of the airfoil to have a first radius and forming a second fillet radially outward from the first fillet to have a second radius smaller than the first radius.

19. The method as recited in claim 18, including forming the first fillet to extend radially from the outer periphery a first distance to an interface and forming the second fillet to begin at the interface.
